(19) United States
(12) Patent Application Publication
(10) Pub. No.: US 2007/0236726 A1
(43) Pub. Date: Oct. 11, 2007

(54) Print enhancement method and system

(76) Inventors: Mark Alan Robb, Lexington, KY (US); David Keith Lane, Stamping Ground, KY (US); Donald J. Kozak, Lexington, KY (US); Taek Kwan Lee, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/401,705

(22) Filed: Apr. 11, 2006

(51) Int. Cl. G06K 15/00

(52) U.S. Cl. 358/1.15; 358/1.12

(57) ABSTRACT

A method, computer program product, and printing system for monitoring an object to be printed at a defined location within a printed page. The object is printed at the defined location within the printed page. The object may then be printed at an alternate location within the printed page. The alternate location may be offset from the defined location by a defined distance in a defined direction.

### TECHNICAL FIELD

This disclosure relates to printing methodologies and, more particularly, to printing methodologies for printing objects that may be positioned at defined and alternate locations within a printed page.

### BACKGROUND

All printing processes have a limit as to how fine a line can be drawn. Unfortunately, when this dimension approaches the thickness of lines used in certain strokes of a font, the print quality of the font may be adversely affected, which is often referred to as dropout or voiding.

Many fonts include vertical strokes (i.e., stems) that are thicker than the horizontal strokes (i.e., arms/bars) used in the font. Accordingly, printing the arms/bars of a font character without dropout/voiding may be a limiting factor with regard to acceptable text print quality.

On some laser printers, it may be difficult to print fine lines that are at right angles to the process direction (i.e., the direction of movement of the media). Because of this printing difficulty, a two-PEL (i.e., pixel element) horizontal line might only print the thickness expected of a single PEL line, and a single PEL horizontal line might not print at all. Accordingly, this may cause a problem with the top of the capital letter “T”, the bottom of the capital letter “L”, and the top and bottom of a capital letter “I”.

### SUMMARY OF THE DISCLOSURE

In one implementation, a method includes monitoring an object to be printed at a defined location within a printed page. The object is printed at the defined location within the printed page. The object is printed at an alternate location within the printed page. The alternate location is offset from the defined location by a defined distance in a defined direction.

In another implementation, a printing system is configured for monitoring an object to be printed at a defined location within a printed page. The object is printed at the defined location within the printed page. The object is printed at an alternate location within the printed page. The alternate location is offset from the defined location by a defined distance in a defined direction.

In another implementation, a computer program product resides on a computer readable medium having a plurality of stored instructions. When executed by a processor, the instructions cause the processor to perform operations comprising monitoring an object to be printed at a defined location within a printed page. The object is printed at the defined location within the printed page. The object is printed at an alternate location within the printed page. The alternate location is offset from the defined location by a defined distance in a defined direction.

One or more of the following features may also be included with respect to any of the above. For example, the defined direction may be essentially parallel to a media feed direction of a printing device processing the object. The defined distance may be at least one pixel element. The object may include a text object. The object may include a graphics object. The object may include at least a portion of a printed page. The darkness of at least one of the objects printed at the defined location and the object printed at the alternate location may be reduced. The method, printing system or computer readable medium may be executed or placed within an image forming device or printer cartridge.

One or more of the following features may also be included. The defined direction may be essentially parallel to a media feed direction of a printing device processing the object. The defined distance may be at least one pixel element. The object may include a text object. The object may include a graphics object. The object may include at least a portion of a printed page. The darkness of at least one of the objects printed at the defined location and the object printed at the alternate location may be reduced. The computer readable medium may be included within an image forming device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printing device and a printer cartridge for use within the printing device;

FIG. 2 is a diagrammatic view of the printing device of FIG. 1 interfaced to the printer cartridge of FIG. 1;

FIG. 3 is a flow chart of a print enhancement process executed by the printing device or the print driver of FIG. 1; and

FIG. 4 is a diagrammatic view of a printed page and a plurality of objects included within the printed page.

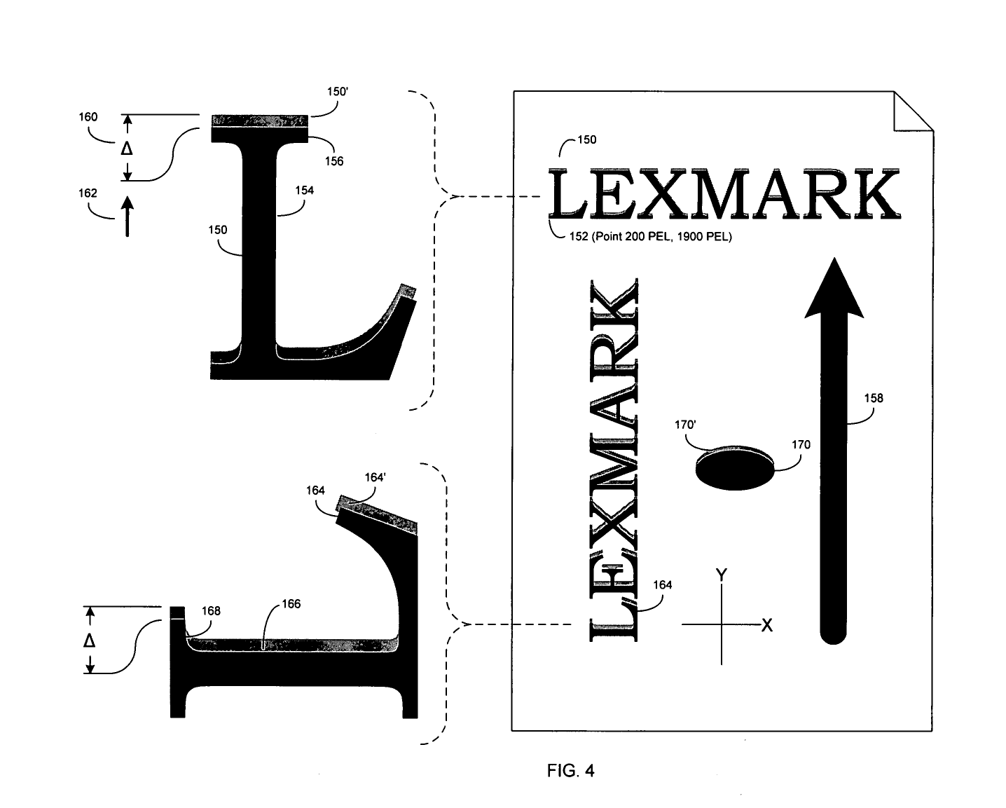

### DETAILED DESCRIPTION OF THE PREFERRED EMBODIMENTS

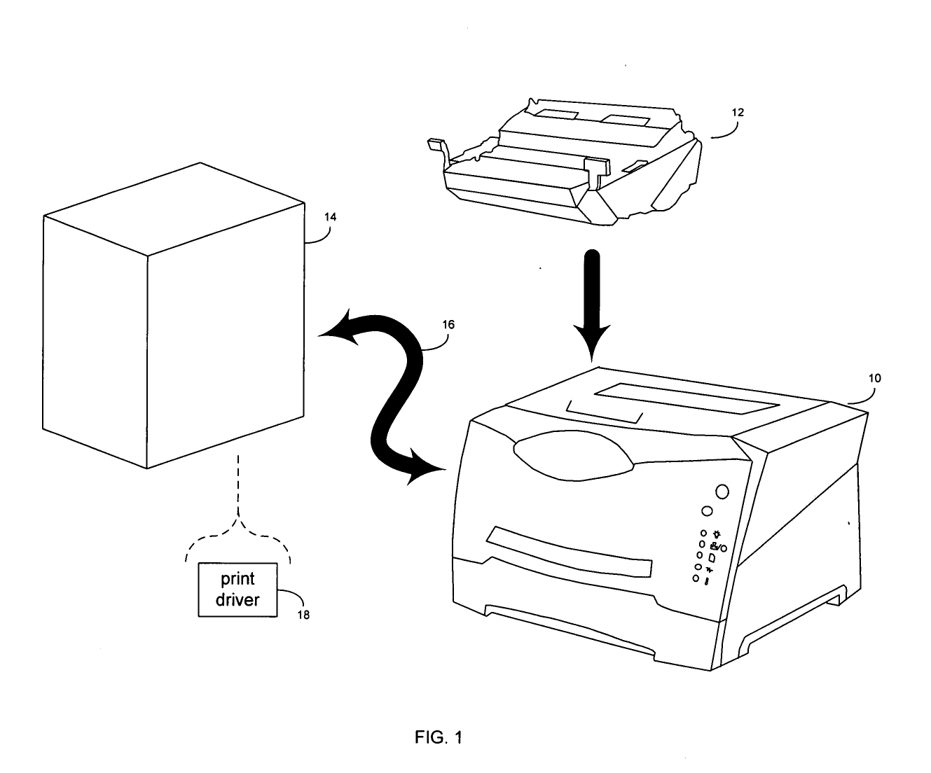

Referring to FIG. 1, there is shown an exemplary image forming or printing device 10 and a printer cartridge 12 for use within printing device 10. The image forming device may therefore include printers, electrophotographic printers, copiers, fax machines, all-in-one devices, multi-functional devices, etc.

Printing device 10 is typically coupled to a computing device 14 via e.g. a parallel printer cable, a universal serial bus cable, and/or a network cable (collectively represented as cable 16). Typically, a print driver 18 is executed on computing device 14 and translates code provided by various programs executed on computing device 14 into code processable by printing device 10.

Printing device 10 may therefore be a device that accepts text and graphic information from a computing device and transfers the information to various forms of media (e.g., paper, cardstock, transparency sheets, etc.). Further, printer cartridge 12 may be a component of printing device 10, which typically includes the consumables/wear components (e.g. toner, drum assembly, and fuser assembly, for example) of printing device 10. Printer cartridge 12 typically also includes circuitry and electronics (not shown) required to e.g., charge the drum and control the operation of printer cartridge 12.

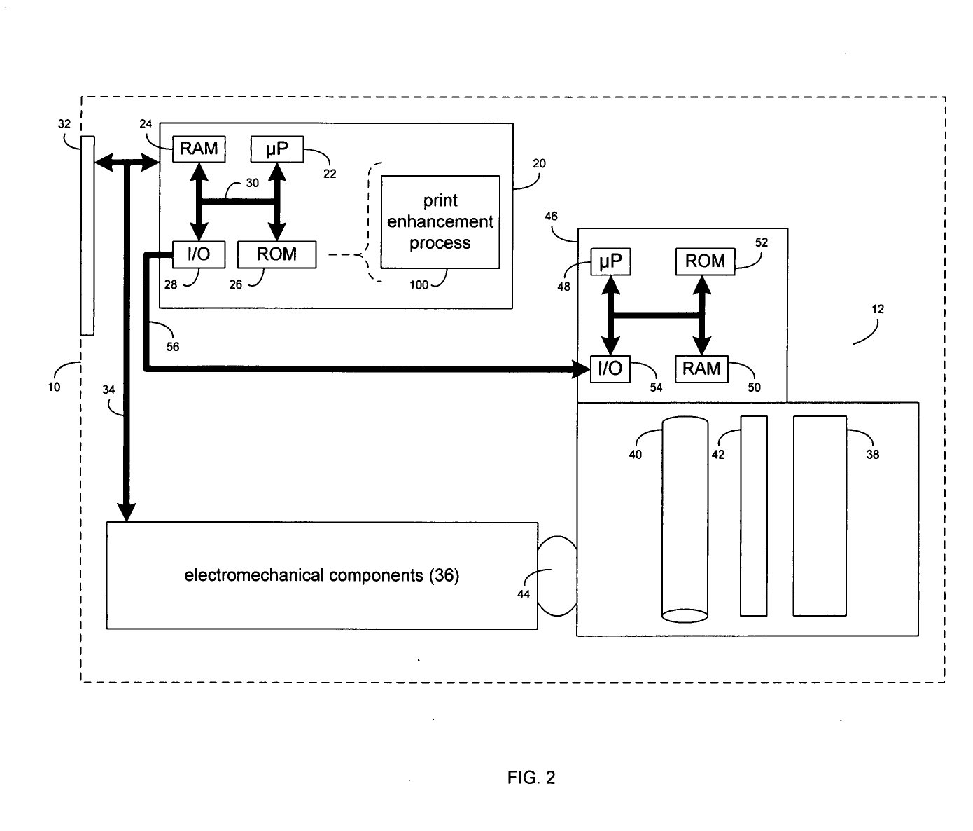

Referring also to FIG. 2, there is shown a diagrammatic view of an exemplary printer cartridge 12 interfaced with printing device 10. Printing device 10 may include a system board 20 for controlling the operation of printing device 10. System board 20 may include a microprocessor 22, random access memory (i.e., RAM) 24, read only memory (i.e., ROM) 26, and an input/output (i.e., I/O) controller 28. Microprocessor 22, RAM 24, ROM 26, and I/O controller 28 may be coupled to each other via data bus 30. Examples of data bus 30 may include a PCI (i.e., Peripheral Component Interconnect) bus, an ISA (i.e., Industry Standard Architecture) bus, or a proprietary bus, for example.

Printing device 10 may include display panel 32 for providing information to a user (not shown). Display panel 32 may include e.g. an LCD (i.e. liquid crystal display) panel, one or more LEDs (i.e., light emitting diodes), and/or one or more switches. Typically, display panel 32 is coupled to I/O controller 28 of system board 20 via data bus 34. Examples of data bus 34 may include a PCI (i.e., Peripheral Component Interconnect) bus, an ISA (i.e., Industry Standard Architecture) bus, or a proprietary bus, for example. Printing device 10 may include electromechanical components 36, such as: feed motors (not shown), gear drive assemblies (not shown), paper jam sensors (not shown), and paper feed guides (not shown), for example. Electromechanical components 36 may be coupled to system board 14 via data bus 34 and I/O controller 28.

As discussed above, printer cartridge 12 may include a toner reservoir 38, toner drum assembly 40, and fuser assembly 42, for example. Typically, electromechanical components 36 are mechanically coupled to printer cartridge 12 via a releasable gear assembly 44 that allows printer cartridge 12 to be removed from printing device 10.

Printer cartridge 12 may include a system board 46 that controls the operation of printer cartridge 12. System board 46 may include microprocessor 48, RAM 50, ROM 52, and I/O controller 54, for example. System board 46 may be releasably coupled to system board 20 via data bus 56, thus allowing for the removal of printer cartridge 12 from printing device 10. Examples of data bus 56 may include a PCI (i.e., Peripheral Component Interconnect) bus, an ISA (i.e., Industry Standard Architecture) bus, an I2C (i.e., Inter-IC) bus, an SPI (i.e., Serial Peripheral Interconnect) bus, or a proprietary bus.

Microprocessor 22 of system board 20 may execute a print enhancement process 100 (to be discussed below in greater detail). The instruction sets and subroutines of print enhancement process 100 may be stored on a storage device (e.g., ROM 26). Other examples of the storage device may include a hard disk drive or an optical drive.

Print Enhancement Process 100

As discussed above, printing processes may have a limit concerning how fine a line can be drawn. For example, on some laser printers it may also be difficult to print fine lines that are at angle such as a right angle to the process direction (i.e., the direction of movement of the media through the printing device). Because of this printing difficulty, a two-PEL horizontal line might only print the thickness expected of a single PEL line, and a single PEL horizontal line might not print at all.

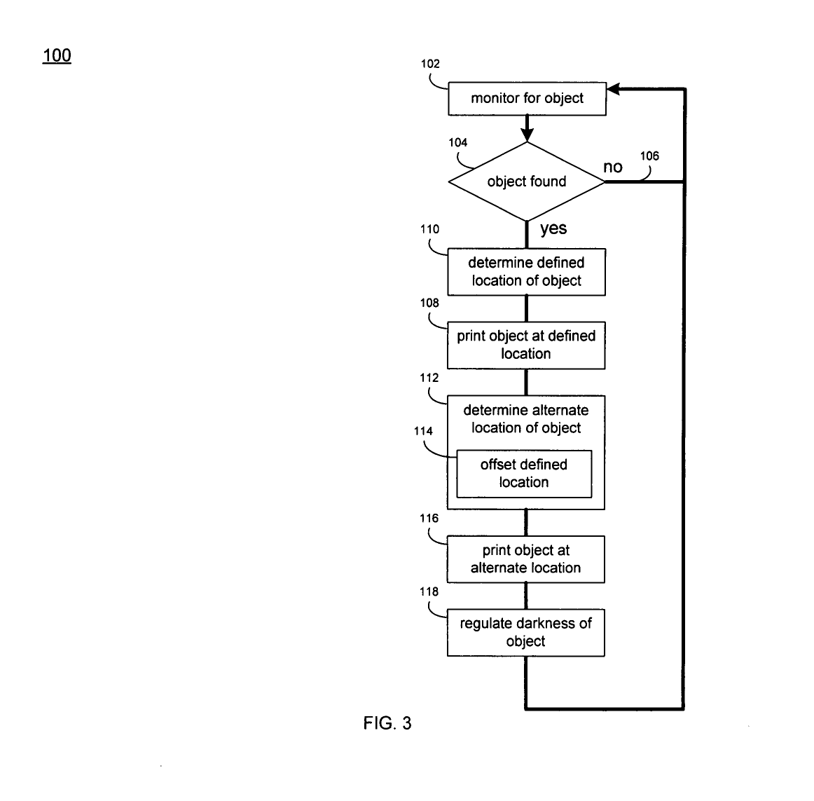

Referring also to FIGS. 3 & 4, print enhancement process 100 may monitor 102 for the occurrence of an object (e.g., a print object) to be printed at a defined location within a printed page. Examples of such objects may include text objects (e.g., the letter “a”), graphics objects (e.g., a JPEG image) and fill objects (e.g., a gradient fill pattern that is used to fill a sphere). Objects may be provided to printing device 10 (FIG. 1) from print driver 18 (FIG. 1) through cable 16 (FIG. 1). A plurality of objects may be bundled into a print job and provided to printing device 10 from print driver 18. A print job may define the page layout and the objects to be included within a single or multi-page print job.

If at 104 an object to be printed is not received by printing device 10, print enhancement process 100 continues 106 to monitor 102 for the occurrence of an object. If at 104 an object is received by printing device 10, printing device 10 may print 108 the received object at a defined location within the printed page. Typically, when an object (e.g., a text object or a graphic object) is received by printing device 10 for printing, the size and shape of the object may be defined, a scaling factor for the object may be defined, and location information concerning the object may be defined.

For example, assuming that a letter “L” 150 is to be printed on a page, the object received by printing device 10 may define the object (e.g., the letter “L” in “Bookman Old Style” font). The scaling factor defined for the object may increase the font size of the object to e.g., 48 point. Additionally, location information concerning the object may define the lower left-hand corner of letter “L” 150 as being positioned at location X=200 PEL (i.e., 200 PELs in from the left hand side of the printed page) and Y=1,900 PEL (i.e., 1,900 PELs up from the bottom of the printed page).

While letter “L” 150 has a considerably thick vertical stem 154, the horizontal bars (e.g., bar 156) are considerably thinner. As bar 156 is perpendicular to process direction 158 (i.e., the direction that media moves through printing device 10), dropout/voiding (as described above) may occur with respect to e.g., bar 156.

In order to reduce the occurrence of dropout/voiding on the printed page, print enhancement process 10 may print an object (e.g., letter “L” 150) two or more times, such that the second printing is offset from the first printing by a defined distance “Δ” 160 and in a defined direction 162.

Continuing with the above stated example, assume that, while print enhancement process 100 is monitoring 102 for the occurrence of objects to be printed by printing device 10, an object is received representative of letter “L” 150. Print enhancement process 100 may determine 110 the defined location of letter “L” 150 (within the printed page) using the above-described position information and scaling factor. The above-described position information and scaling factor are for illustrative purposes only and are not intended to be a limitation of this disclosure, as other positioning and locating methodologies may be utilized.

In addition to the defined location being determined by print enhancement process 100, an alternate location may be determined 112 for the object being printed (e.g., letter “L” 150). When determining 112 the alternate location of letter “L” 150, the object is offset in a defined distance “Δ” 160 and in a defined direction 162. Defined distance “Δ” 160 may be greater than or equal to one PEL. Additionally, defined direction 162 may be the process direction (i.e., the direction that media moves through printing device 10). Accordingly and continuing with the above-stated example, as the defined location for letter “L” is (X=200 PELs, Y=1,900 PELs), assuming that defined distance “Δ” 160 is 1 PEL and defined direction 162 is the positive movement along the Y axis (i.e., the direction that media moves through printing device 10), print enhancement process 100 may determine 112 the alternate location for letter “L” 150 as (X=201 PELs, Y=1,901 PELs).

Print enhancement system 10 may then print 108 the letter “L” 150 at defined location (X=200 PELs, Y=1,900 PELs) and print 116 a second occurrence 150′ of the letter “L” at the alternate location (X=201 PELs, Y=1,901 PELs). In this example, the first occurrence of letter “L” (i.e., letter “L” 150) is shown to be black in color and the second occurrence of letter “L” (i.e., letter “L” 150′) is shown to be gray in color and partially obscured by the first occurrence of letter “L” (i.e., letter “L” 150).

Accordingly, by printing the letter “L” multiple times (e.g., a first printing as letter “L” 150 and a second printing as letter “L” 150′), wherein the second printing is offset along the Y-axis (i.e., the direction that media moves through printing device 10) by e.g., 1 PEL, the thickness of the horizontal components of the letter “L” will be increased by 1 PEL due to the combination of the printings of letter “L” 150 and letter “L” 150′.

Once the object being processed is printed the required number of times, print enhancement process 100 may continue to monitor 102 for additional objects to be processed.

While the object being processed is described above as a text object (i.e., the letter “L” having a vertical or portrait orientation, other configurations are possible. For example, the object being processed may be a text object (letter “L” 164) having a horizontal or landscape orientation. When orientated horizontally, the thicker stem 166 is now horizontal and the thinner bar 168 is now vertical. However, since dropout/voiding typically may occur along the X-axis (i.e., perpendicular to the direction that media moves through printing device 10), dropout/voiding will typically not occur with respect to thinner bar 168. Additionally, as the now horizontal stem 166 is typically substantially thicker than the thinner vertical bar 168, dropout/voiding will typically not occur with respect to horizontal stem 166. However, print enhancement process 100 may still process vertically orientated text objects, resulting in the vertical letter “L” being printed multiple times (e.g., a first printing as letter “L” 164 and a second printing as letter “L” 164′). As the second printing is offset along the Y-axis (i.e., the direction that media moves through printing device 10) by e.g., 1 PEL, the thickness of the horizontal components (e.g., stem 166) of the letter “L” will be increased by 1 PEL due to the combination of the printings of letter “L” 164 and letter “L” 164′.

In addition to text objects, other object types may be shifted and repetitively printed. For example, a graphics object (such as an ellipse) may be initially located 110, printed 108 at the original location as ellipse 170, shifted 112 to an alternate location, and printed 116 at the alternate location as ellipse 170′. While this may result in a more circular ellipse, the change may be minor and may not generally affect the appearance of the resulting image.

In the event that the images being overlaid are not solid images, print enhancement process may regulate 118 the darkness of one or more of the overlaid images so that the resulting combined image (e.g., the image formed by overlaying ellipse 170 and ellipse 170′) is not darker than intended. For example, print enhancement process 10 may maintain and use an alternate set of halftone screens that are linearized to compensate for the image modification.

In addition to text objects and graphics object, print enhancement process 10 may process an entire printed page at a time. For example, when charging drum assembly 40 to include the image of a printed page, a second copy of the printed page may be applied to the drum assembly, such that the second copy of the printed page is offset e.g., 1 PEL in the Y axis.

While print enhancement process 100 is described above as being executed by processor 22 and stored on ROM 26, other configurations are possible. For example, print enhancement process 100 may be executed by processor 48 and stored on ROM 52. Therefore, print enhancement process 100 may be executed in a printer cartridge. Print enhancement process 100 may also be a portion of print driver 18. Therefore, instead of print driver 18 providing individual objects to printing device 10, print driver 18 may process the objects to be sent to printing device 10. Therefore, in this embodiment, prior to providing an object to printing device 10, print driver 18 may combine the originally located object with an offset version of the object to form a hybrid object. This hybrid object may then be provided to printing device 10 for positioning within the printed page. Print enhancement process may therefore be executed in an image forming device or in a printer cartridge.

As alluded to above, while printer cartridge 12 is shown and discussed above as being a laser printer cartridge 12, other configurations are possible and are considered to be within the scope of this disclosure. For example, printer cartridge 12 may be an inkjet printer cartridge and printing device 10 may be an inkjet printer. Alternatively, printer cartridge 12 may be a dye sublimation printer cartridge and printing device 10 may be a dye sublimation printer. Further, printer cartridge 12 may be a thermal wax printer cartridge and printing device 10 may be a thermal wax printer.

A number of implementations have been described. Nevertheless, it will be understood that various modifications may be made. Accordingly, other implementations are within the scope of the following claims.

What is claimed is:

1. A method comprising:
monitoring an object to be printed at a defined location within a printed page;
printing the object at the defined location within the printed page; and
printing the object at an alternate location within the printed page, wherein the alternate location is offset from the defined location by a defined distance in a defined direction.

2. The method of claim 1 wherein the defined direction is essentially parallel to a media feed direction of a printing device processing the object.

3. The method of claim 1 wherein the defined distance is at least one pixel element.

4. The method of claim 1 wherein the object includes a text object.

5. The method of claim 1 wherein the object includes a graphics object.

6. The method of claim 1 wherein the object includes at least a portion of a printed page, the method further comprising:
reducing the darkness of at least one of the object printed at the defined location and the object printed at the alternate location.

7. The method of claim 1 wherein the method is executed in an image forming device.

8. The method of claim 1 wherein the method is executed in a printer cartridge.

9. A printing system configured for:
monitoring an object to be printed at a defined location within a printed page;
printing the object at the defined location within the printed page; and
printing the object at an alternate location within the printed page, wherein the alternate location is offset from the defined location by a defined distance in a defined direction.

10. The printing system of claim 9 wherein the defined direction is essentially parallel to a media feed direction of a printing device processing the object.

11. The printing system of claim 9 wherein the defined distance is at least one pixel element.

12. The printing system of claim 9 wherein the object includes a text object.

13. The printing system of claim 9 wherein the object includes a graphics object.

14. The printing system of claim 9 wherein the object includes at least a portion of a printed page, the printing system further configured for:
reducing the darkness of at least one of the object printed at the defined location and the object printed at the alternate location.

15. The printing system of claim 9 wherein the printing system is included in an image forming device.

16. The printing system of claim 9 wherein the printing system is included in a printer cartridge.

17. A computer program product residing on a computer readable medium having a plurality of instructions stored thereon which, when executed by a processor, cause the processor to perform operations comprising:
monitoring an object to be printed at a defined location within a printed page;
printing the object at the defined location within the printed page; and
printing the object at an alternate location within the printed page, wherein the alternate location is offset from the defined location by a defined distance in a defined direction.

18. The computer program product of claim 17 wherein the defined direction is essentially parallel to a media feed direction of a printing device processing the object.

19. The computer program product of claim 17 wherein the defined distance is at least one pixel element.

20. The computer program product of claim 17 wherein the object includes a text object.

21. The computer program product of claim 17 wherein the object includes a graphics object.

22. The computer program product of claim 17 wherein the object includes at least a portion of a printed page, the computer program product further comprising instructions to perform operations comprising:
reducing the darkness of at least one of the object printed at the defined location and the object printed at the alternate location.

23. The computer program product of claim 17 wherein the computer readable medium is included in an image forming device.

24. The computer program product of claim 17 wherein the computer readable medium is included in a printer cartridge.
